(19) United States
(12) Patent Application Publication
(10) Pub. No.: US 2017/0160067 A1
(43) Pub. Date: Jun. 8, 2017

(54) Alignment tool for outside corners

(71) Applicant: Mark Gallo, Pennellville, NY (US)

(72) Inventor: Mark Gallo, Pennellville, NY (US)

(73) Assignee: Mark Andrew Gallo, Pennellville, NY (US)

(21) Appl. No.: 15/208,426

(22) Filed: Jul. 12, 2016

Related U.S. Application Data
(60) Provisional application No. 62/192,650, filed on Jul. 15, 2015.

(51) Int. Cl. G01B 5/25; G01C 9/00

(52) U.S. Cl. CPC G01B 5/25; G01C 9/00

(57) ABSTRACT

An alignment tool for a corner post includes a body portion including first and second arms. Each of the first and second arms include an inner member and an outer member. The inner member has an engagement face. The outer member has an inner surface. A pivot is coupled between the first and second arms. The pivot is configured to position the first and second arms of the body portion between a closed position and an open position. The engagement faces of the inner members and the inner surfaces of the outer members together define a mounting area while the body portion is disposed in the open position. The mounting area receives the corner post therein. One or more aliment devices are secured to the body portion.

### TECHNICAL FIELD

The present disclosure relates to tools for installing siding on a building. More specifically, the present disclosure relates to alignment tools for securing outside corner posts to buildings.

### BACKGROUND

Siding is generally applied to the exterior of a building, typically a house. For example, vinyl siding is applied to the exterior walls of a house in horizontal strips. At the corners of the exterior walls, a corner post is often used to support and conceal the ends of these horizontal strips to create a finished look. Corner posts can be eight or more feet long and have a tendency to be flexible, making it challenging to hold the corner post in the correct alignment while securing the corner post to the exterior walls of the building. Proper alignment of these corner posts on the exterior walls is necessary to achieve proper alignment of the horizontal strips that the corner posts support and conceal. Thus, without proper alignment of the corner posts, the horizontal strips are also likely to be misaligned, jeopardizing not only the appearance of the installation, but also the integrity the installation. Accordingly, a need exists to provide a tool that can maintain these corner posts in proper alignment for improving installation efficiency.

### SUMMARY

The present disclosure is directed to an alignment tool for a corner post. The alignment tool includes a body portion including first and second arms. Each of the first and second arms includes an inner member and an outer member. The inner member has an engagement face. The outer member has an inner surface. A pivot is coupled between the first and second arms. The pivot is configured to position the first and second arms of the body portion between a closed position and an open position. The engagement faces of the inner members of the first and second arms, and the inner surfaces of the outer members of the first and second arms, together define a mounting area while the body portion is disposed in the open position. The mounting area is configured to receive the corner post therein. One or more alignment devices are secured to the body portion.

In embodiments, the one or more alignment devices may include a leveling device, a plumbing device, or combinations thereof.

In some embodiments, a first one of the inner members may be slidably coupled to a first one of the outer members. A pin may couple a first one of the inner members to a first one of the outer members. The first one of the inner members may define an elongate slot that receives the pin therein. The elongate slot may define one or more separating features that separate the elongate slot into separate lengths. The pin may be movable between the separate lengths to adjust a size of the mounting area.

In certain embodiments, the body portion may include indicia thereon.

In some embodiments, the body portion may include a locking feature to selectively lock the body portion in the closed position.

In the open position, the inner surfaces of the outer members of the first and second arms may define an angle of approximately 90 degrees.

In embodiments, the engagement faces of the first and second arms may complement legs of the corner post.

In certain embodiments, the body portion may include wood material, ceramic material, metallic material, polymeric material, or combinations thereof.

In embodiments, the inner members may be fixed relative to the outer members to maintain a fixed mounting area.

The inner members may be selectively securable to respective outer members at a plurality of predetermined locations along the respective outer members. Each of the plurality of predetermined locations may correspond to a different-sized mounting area. The inner members may be movable relative to the respective outer members to adjust the mounting area between at least 3 inch, 4 inch, and 5 inch sizes.

In some embodiments, the inner and outer members of the first and second arms include teeth that selectively maintain the first and second arms in locked positions.

Other aspects, features, and advantages will be apparent from the description, the drawings, and the claims that follow.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description given below, serve to explain the principles of the disclosure, wherein:

FIG. 1 is a top view of one embodiment of a corner post alignment tool in a closed position;

FIG. 2 is a top view of the corner post alignment tool of FIG. 1 in an open position;

FIGS. 3 and 4 are side views of the corner post alignment tool of FIGS. 1-2;

FIG. 5 is a perspective view of the corner post alignment tool in the open position as shown in FIG. 2;

FIG. 6 is a perspective view of an exemplary building having corner posts and horizontal strips of siding secured thereto;

FIG. 7 is a perspective view of an end portion of an exemplary corner post;

FIG. 8 is a perspective view of the corner post alignment tool of FIGS. 1-5 shown positioned on a corner post;

FIG. 9 is a perspective view of another embodiment of a corner post alignment tool;

FIG. 10 is a top view of yet another embodiment of a corner post alignment tool; and

FIGS. 11A-11C are progressive views of still another embodiment of a corner post alignment tool.

### DETAILED DESCRIPTION

Embodiments of the presently disclosed devices are described in detail with reference to the drawings, in which like reference numerals designate identical or corresponding elements in each of the several views. As used herein, the term “distal” or “leading” refers to that portion of the device that is farther from the user, while the term “proximal” or “trailing” refers to that portion of the device that is closer to the user.

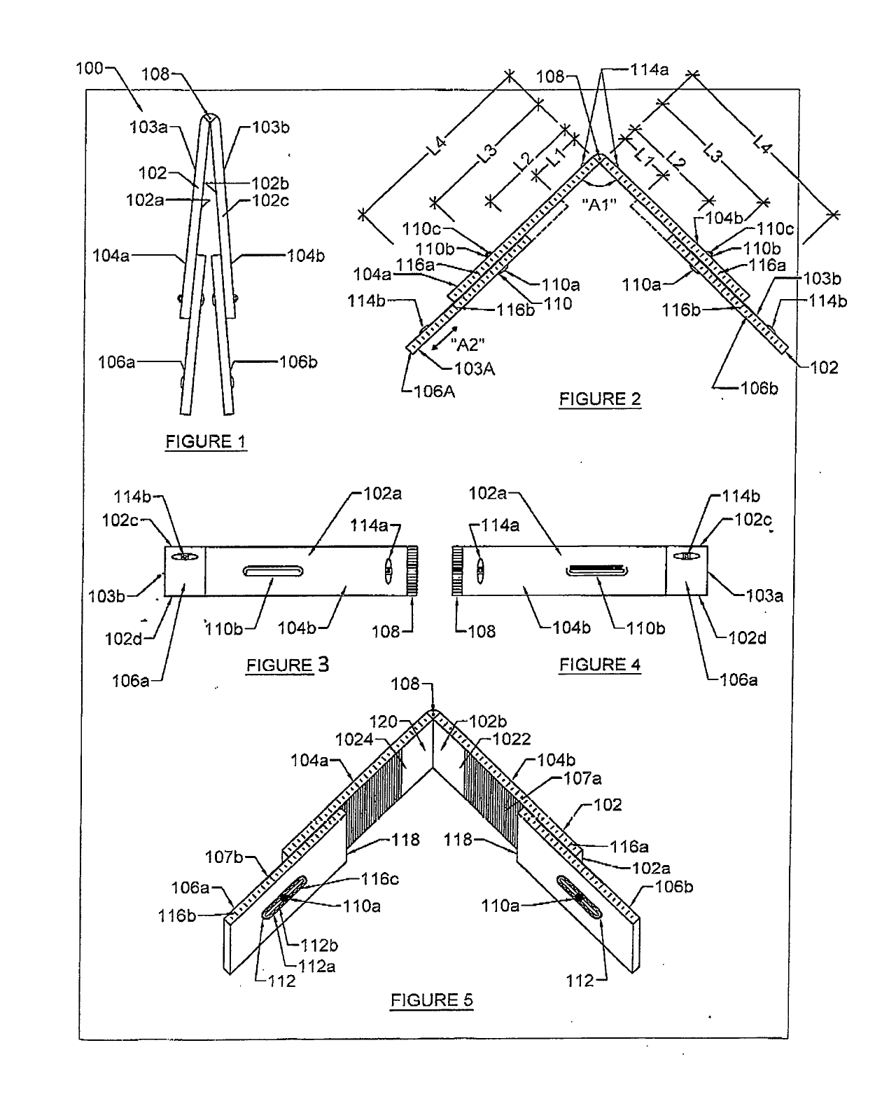

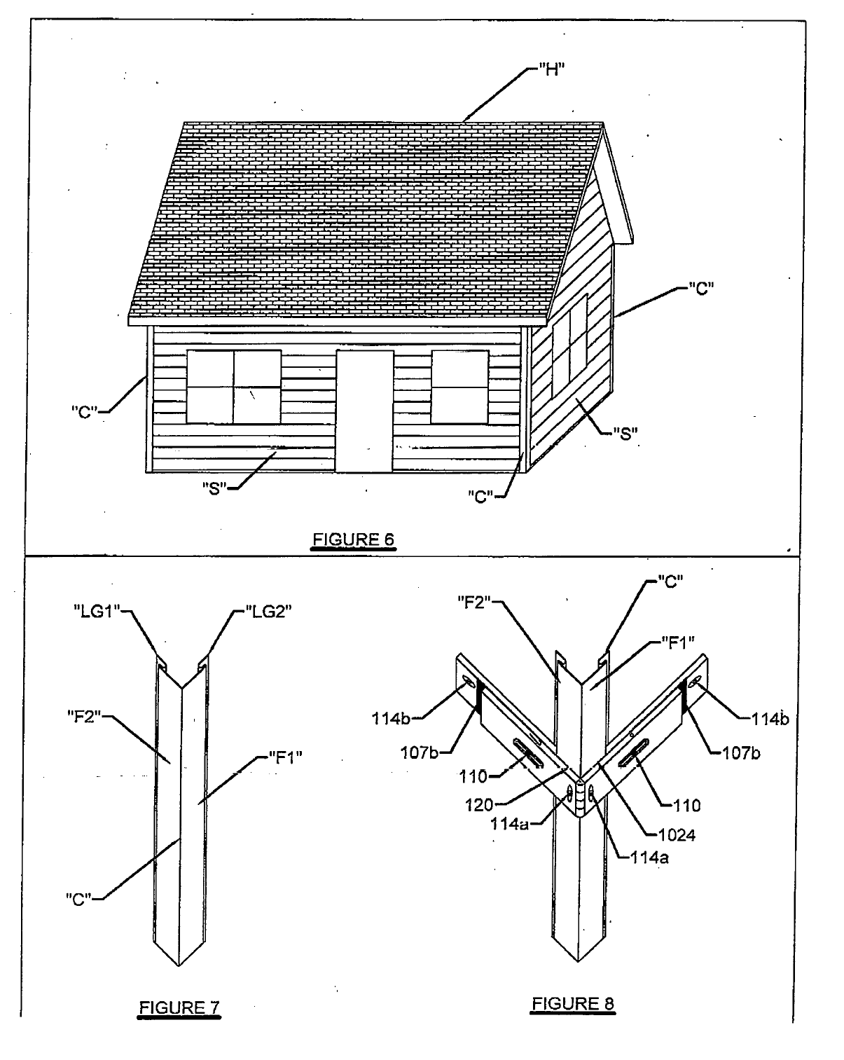

Turning now to FIGS. 1-8, one embodiment of an alignment tool for a corner post is generally referred to as alignment tool 100. Alignment tool 100 includes a body portion 102 having an outer surface 102a, an inner surface 102b, a top surface 102c, and a bottom surface 102d. Body portion 102 includes a first arm 103a and a second arm 103b. First arm 103a includes an outer member 104a and an inner member 106a. Second arm 103b includes an outer member 104b and an inner member 106b. Outer and inner members 104a, 104b, 106a, 106b may include teeth 107a, 107b, respectively, that selectively enmesh with one another. First and second arms 103a, 103h are coupled together by a pivot 108 that enables first and second arms 103a, 103b to pivot between a closed position (FIG. 1) and an open position (FIG. 2) as illustrated by arrows “A1.” In embodiments, the first and second arms 103a, 103b may be configured to pivot inwardly towards one another from the open position to the closed position, and outwardly, away from each other from the closed position to the open position. In the open position, inner surfaces 1022, 1024 of outer members 104a, 104b may be positioned and/or fixed at any suitable angle “α,” depending on the design of a corner post “C” (see FIGS. 6-8). For example, pivot 108 may be configured to pivot first and second arms 103a, 103b so that inner surfaces 1022, 1024 of outer members 104a, 104b are 90 degrees (or approximately 90 degrees) apart to define a mounting or corner post receiving area 120 between the first and second arms 103a, 103b. In particular, the mounting or corner post receiving area 120 is defined between the inner surfaces 1022, 1024 of outer members 104a, 104b and engagement faces 118 of inner members 106a, 106b.

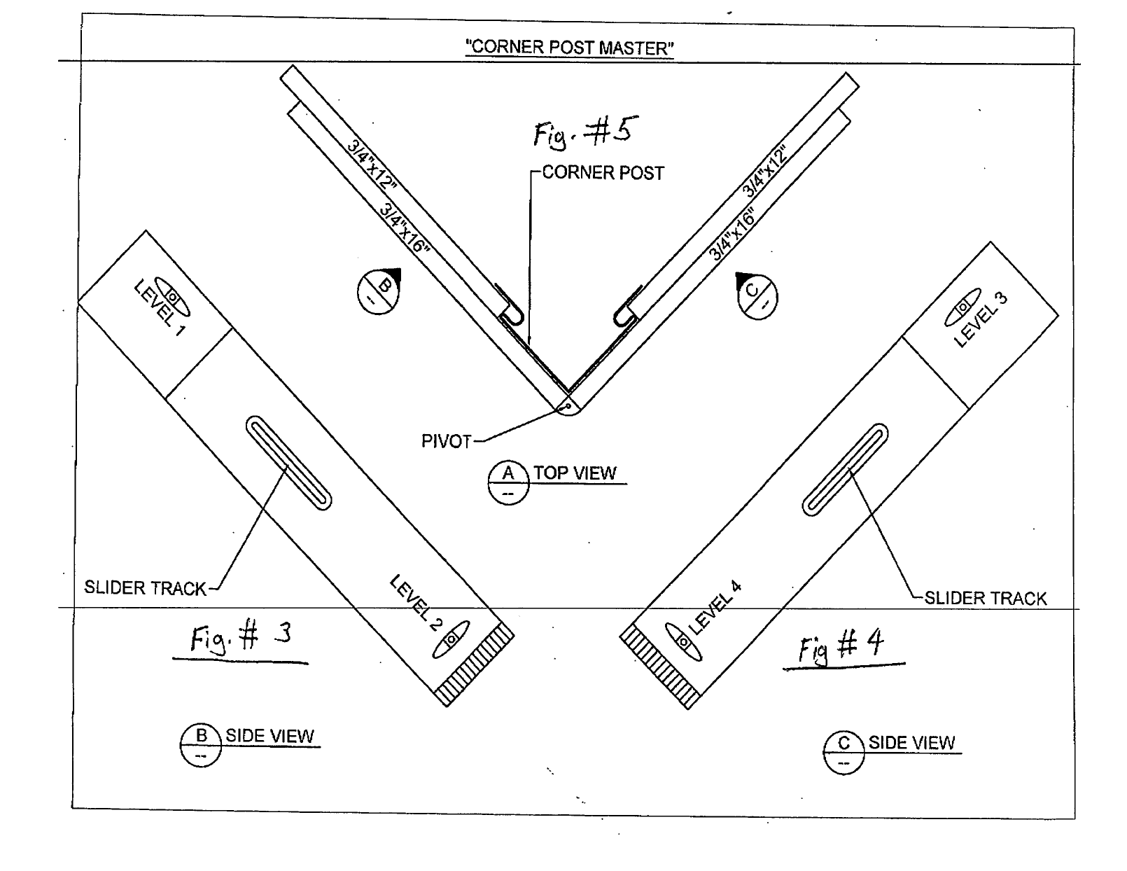

A pin assembly 110 secures inner members 106a, 106b to outer members 104a, 104b so that inner members 106a, 106b extend distally beyond outer members 104a, 104b. Pin assembly 110 includes a pin 110a and a nut 110b that are positionable between a locking position and an unlocked position as described in greater detail below. In embodiments, pin 110a and nut 110b may be threadably coupled. In some embodiments, nut 110b may include any suitable nut retaining feature 110c such as a cap or cotter pin to maintain nut 110b secured to pin 110a. Outer members 104a, 104b define elongate slots 112 that receive pin assemblies 110 to enable inner members 106a, 106b to slidably move relative to outer members 104a, 104b while pin assembly 110 is disposed in the unlocked position. Elongate slots 112 can include one or more separating features such as ridges 112a, 112b that separate elongate slots into separate sections or compartments corresponding to various positions of inner members 106a, 10613 relative to outer members 104a, 104b. These various positions correspond to various corner post receiving area lengths (e.g., L1, L2, L3, L4, etc.) (see FIG. 2) of corner post receiving area 120 (see FIG. 5) so that corner post receiving area 120 can be adjusted to receive different sized corner posts “C” such as 3 inch, 4 inch, or 5 inch corner posts, for example.

In the locking position of pin assembly 110, pin 110a and nut 110b maintain inner members 106a, 106b in a close or approximated position relative to respective outer members 104a, 104b such that respective outer and inner members 104a, 104b, 106a, 106b are locked together in fixed relative positions. For example, nut 110b can be selectively moved along pin 110a (e.g. threaded up pin 110a) to approximate respective outer and inner members 104a, 104b, 106a, 106b toward one another to fix a position of inner members 106a, 106b relative to respective outer members 104a, 104b via frictional engagement of opposing surfaces of respective inner and outer members 104a, 104b, 106a, 106b. In particular, teeth 107a, 107b of respective outer and inner members 104a, 104b, 106a, 106b may be configured to enmeshed in the locked position to enhance the frictional engagement between respective opposing surfaces of inner and outer members 104a, 104b, 106a, 106b.

In the unlocked position of pin assembly 110, nut 110b is loosened on pin 110a (e.g. threaded down pin 110a) to maintain respective outer and inner members 104a, 104b, 106a, 106b slightly separated or unapproximated relative to one another to limit frictional engagement between respective outer and inner members 104a, 104b, 106a, 106b and enable outer and inner members 104a, 104b, 106a, 106b to slide relative to one another, respectively, as indicated by arrows “A2.” In the unlocked position of pin assembly 110, teeth 107a, 107b of respective outer and inner members 104a, 104b, 106a, 106b are separated to facilitate sliding movement between respective outer and inner members 104a, 104b, 106a, 106b.

One or more alignment devices 114a, 114b (e.g., a level, a plumb, etc.) can be secured to first and/or second arms 103a, 103b. For example, one or more vertically-oriented devices 114a can be positioned on one or both of outer members 104a, 104b on the proximal ends thereof adjacent to pivot 108 to facilitate a plumbing of a corner post “C.” Additionally, or alternatively, one or more horizontally-oriented devices 114b can be positioned on one or both of inner members 106a. 106b adjacent to the distal ends thereof to facilitate a leveling of a corner post “C.”

Indicia or markings 116a, 116b such as lines, numbers, characters, symbols, and/or the like may be provided on one or more of the surfaces of first and/or second arms 103a, 103b. The markings 116a, 116b can be positioned to facilitate proper alignment of outer and inner members 104a, 104b, 106a, 106b relative to one another and/or to facilitate measurement.

In use, as seen in FIGS. 6-8, alignment tool 100, while disposed in the open position thereof is positioned on a corner post “C” so that corner post “C” is received within corner post receiving area 120 with inner surfaces 1022, 1024 of outer members 104a, 104b abutted against faces “F1” and “F2” of corner post “C” and engagement faces 118 of inner members 106a, 106b abutting legs “LG1” and “LG2” of corner post “C.” The one or more alignment devices 114a, 114b and/or markings 116a, 116b can be utilized to align (e.g., plumb and/or level) corner post “C” in position on a building or house “H.” Once the corner post “C” is aligned as desired, the corner post “C” can be secured to the house “H” for attaching horizontal strips “S” of siding to the house “H.” The process can be repeated for additional corner posts “C” as necessary. To accommodate different-sized corner posts “C,” the first and/or second arms 103a, 103b and/or the pin assemblies 110 can be adjusted as detailed herein. Alignment tool 100 can be positioned or folded into the closed position (FIG. 1) to facilitate easy storing and/or transport.

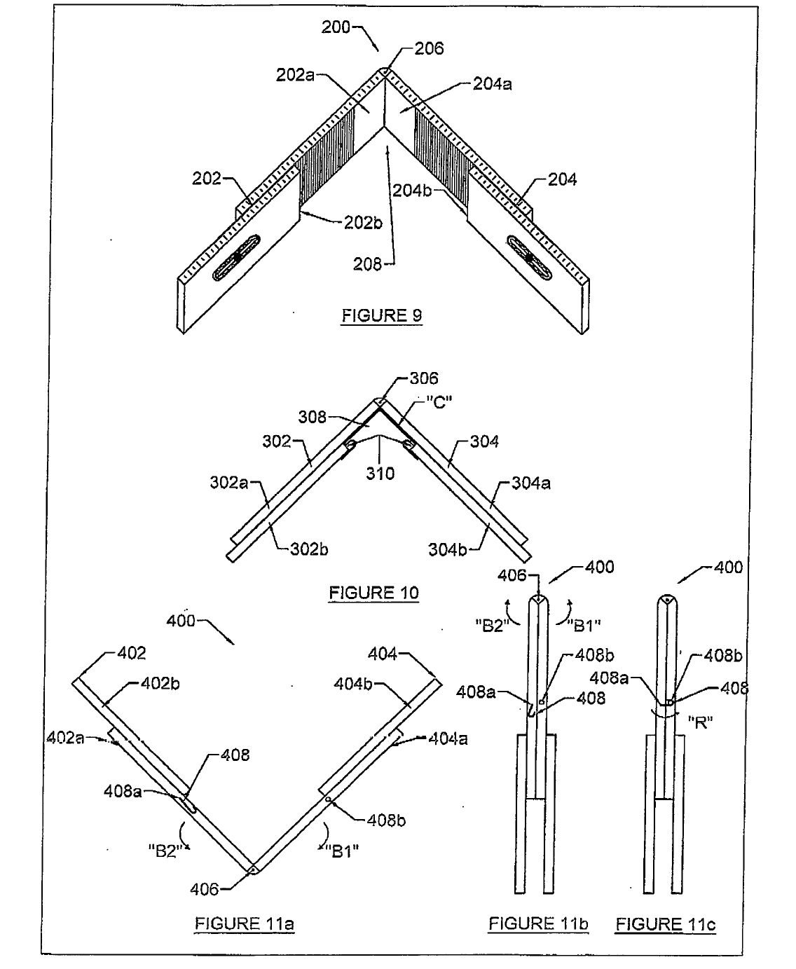

As seen in FIG. 9, one embodiment of an alignment tool 200 includes a first arm 202 and a second arm 244 that are pivotally coupled together via a pivot 206. First arm 202 includes an inner surface 202a and first engagement face 202b. Second arm 204 includes an inner surface 204a and a second engagement face 204b. Inner surface 202a, 202b of first and second arms 202, 204 have a fixed length “FL.” First and second engagement faces 202b, 204b are fixed, and together with inner surfaces 202a, 204a of respective first and second arms 202, 204, define a fixed rod receiving area 208 configured to receive a corner post “C.” In some embodiments, rod receiving area 208 can be configured to receive a single sized corner post “C.”

As seen in FIG. 10, one embodiment of an alignment tool 300 includes first and second arms 302, 304 pivotably coupled via a pivot 306. First and second arms 302, 304 have respective outer members 302a, 304a and respective inner members 302b, 304b. One or both of inner members 302b, 304b include a stepped engagement face 310 to facilitate reception of a corner post “C” and/or different sized corner posts “C” within a rod receiving area 308.

With reference to FIGS. 11A-11C, one embodiment of an alignment tool 400 includes first and second arms 402, 404 having respective outer members 402a, 404a and respective inner members 402b, 404b. First and second arms 402, 404 are pivotably coupled via a pivot 406 that is configured to enable alignment tool 400 to move between an open state (FIG. 11A) and a closed state (FIG. 11B). First and second arms 402, 404 rotate outwardly toward each other, as indicated by arrows “B1,” as alignment tool 400 moves from the open position toward the closed position. Similarly, first and second arms 402, 404 rotate outwardly toward each other, as indicated by arrows “B2,” as alignment tool 400 moves from the closed position to the open position. Alignment tool 400 farther includes a locking feature 408 configured to lock first and second arms 402, 404 together. Locking feature 408 may include a pivotable hook 408a and an anchor 408b that receives anchor 408b. As seen in FIG. 11C, pivotable hook 408a can pivot towards anchor 408b, as indicated by arrow “R,” and fixedly latch onto anchor 408b to selectively lock the first and second arms 402, 404 together. Pivotably hook 408a can be pivoted away from anchor 408b to unlock the alignment tool 400.

In embodiments, first and second arms 402, 404 are spring biased toward the open position.

Any of the presently disclosed alignment tools, or components thereof, can be formed of any suitable wooden, ceramic, metallic and/or polymeric materials.

In some embodiments, any of the presently disclosed alignment tools may include a locking feature such as a pivot lock (not shown) to selectively maintain the respective alignment tool in one or more fixed open and/or closed positions.

Persons skilled in the art will understand that the structures and methods specifically described herein and shown in the accompanying figures are non-limiting exemplary embodiments, and that the description, disclosure, and figures should be construed merely as exemplary of particular embodiments. It is to be understood, therefore, that the present disclosure is not limited to the precise embodiments described, and that various other changes and modifications may be effected by one skilled in the art without departing from the scope or spirit of the disclosure. Additionally, the elements and features shown or described in connection with certain embodiments may be combined with the elements and features of certain other embodiments without departing from the scope of the present disclosure, and that such modifications and variations are also included within the scope of the present disclosure. Accordingly, the subject matter of the present disclosure is not limited by what has been particularly shown and described.

1. An alignment tool for a corner post comprising:
a body portion including first and second arms, each of the first and second arms including an inner member and an outer member, the inner member having an engagement face, the outer member having an inner surface;
a pivot coupled between the first and second arms, the pivot configured to position the first and second arms of the body portion between a closed position and an open position,
wherein the engagement faces of the inner members of the first and second arms, and the inner surfaces of the outer members of the first and second arms, together define a mounting area while the body portion is disposed in the open position, the mounting area configured to receive the corner post therein; and
at least one alignment device secured to the body portion and configured to align the corner post.

2. The alignment tool of claim 1, wherein the at least one alignment device includes a leveling device, a plumbing device, or combinations thereof.

3. The alignment tool of claim 1, wherein a first one of the inner members is slidably coupled to a first one of the outer members.

4. The alignment tool of claim 1, further including a pin that couples a first one of the inner members to a first one of the outer members.

5. The alignment tool of claim 4, wherein the first one of the inner members defines an elongate slot that receives the pin therein.

6. The alignment tool of claim 5, wherein the elongate slot defines at least one separating feature that separates the elongate slot into separate compartments, the pin movable between the separate compartments to adjust a size of the mounting area.

7. The alignment tool of claim 1, wherein the body portion includes indicia thereon.

8. The alignment tool of claim 1, wherein the body portion includes a locking feature to selectively lock the body portion in the closed position.

9. The alignment tool of claim 1, wherein in the open position, the inner surfaces of the outer members of the first and second arms define an angle of approximately 90 degrees.

10. The alignment tool of claim 1, wherein the engagement faces of the first and second arms complement legs of the corner post.

11. The alignment-tool of claim 1, wherein the body portion includes wood material, ceramic material, metallic material, polymeric material, or combinations thereof.

12. The alignment tool of claim 1, wherein the inner members are fixed relative to the outer members to maintain a fixed mounting area.

13. The alignment tool of claim 1, wherein the inner members are selectively securable to respective outer members at a plurality of predetermined locations along the respective outer members, each of the plurality of predetermined locations corresponding to a different-sized mounting area.

14. The alignment tool of claim 14, wherein the inner members are movable relative to the respective outer members to adjust the mounting area between at least 3 inch, 4 inch, and 5 inch sizes.

15. The alignment tool of claim 1, wherein the inner and outer members of the first and second arms include teeth that selectively maintain the first and second arms in locked positions.
